(19) United States
(12) Patent Application Publication
(10) Pub. No.: US 2025/0246613 A1
(43) Pub. Date: Jul. 31, 2025

(54) POSITIVE ELECTRODE ACTIVE MATERIAL, METHOD FOR MANUFACTURING POSITIVE ELECTRODE ACTIVE MATERIAL, AND FLUORIDE ION SECONDARY BATTERY

(71) Applicant: HONDA MOTOR CO., LTD., Tokyo (JP)

(72) Inventor: Kazuyuki SATO, Saitama (JP)

(21) Appl. No.: 18/988,798

(22) Filed: Dec. 19, 2024

(30) Foreign Application Priority Data
Jan. 29, 2024 (JP) 2024-011322

(51) Int. Cl. H01M 4/38; H01M 4/02; H01M 4/58; H01M 10/054

(52) U.S. Cl. CPC H01M 4/38; H01M 4/582; H01M 2004/021; H01M 10/054

(57) ABSTRACT

Provided is a positive electrode active material for use in a fluoride ion secondary battery. The positive electrode active material includes Cu particles and Bi particles. In an XRD spectrum measured using Cu-Kα rays, a first peak is present in a range where a diffraction angle 2θ is 26.2±0.15 degrees, a second peak is present in a range where the diffraction angle 2θ is 30.4±0.25 degrees, and a third peak is present in a range where the diffraction angle 2θ is 27.0±0.25 degrees.

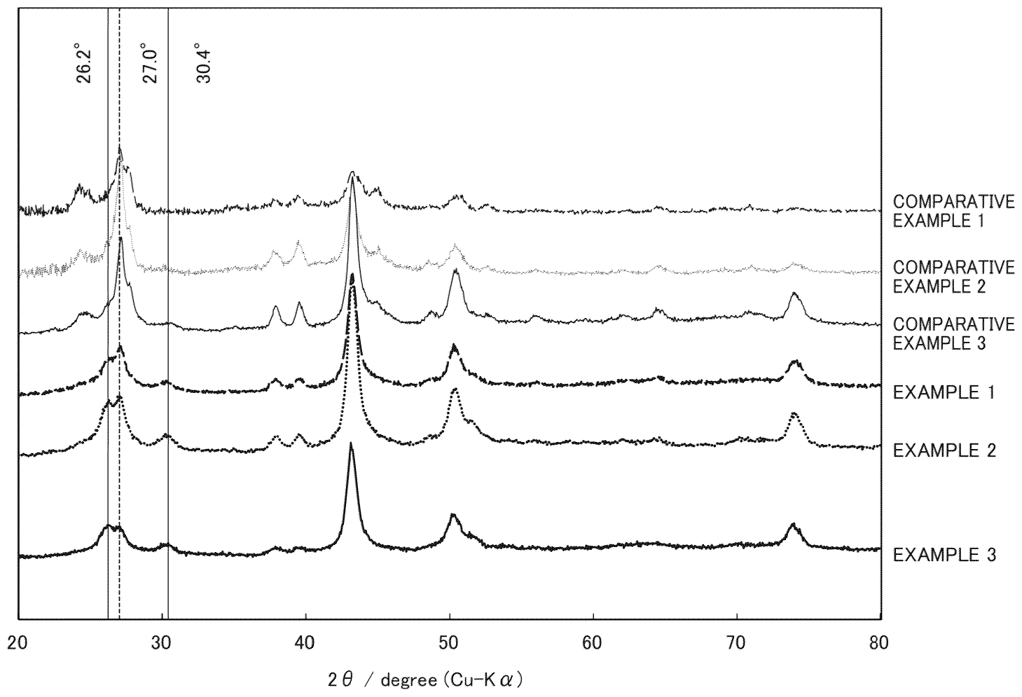

This application is based on and claims the benefit of priority from Japanese Patent Application No. 2024-011322, filed on 29 Jan. 2024, the content of which is incorporated herein by reference.

### BACKGROUND OF THE INVENTION

### Field of the Invention

The present invention relates to a positive electrode active material for use in a fluoride ion secondary battery, a method for manufacturing the positive electrode active material, and a fluoride ion secondary battery.

### Related Art

In recent years, research and development has been conducted on secondary batteries that contribute to energy efficiency in order to ensure that many people have access to affordable, reliable, sustainable, and advanced energy.

Japanese Unexamined Patent Application, Publication No. 2018-73753 discloses a fluoride ion battery including at least a positive electrode active material layer and a solid electrolyte layer. The positive electrode active material layer includes positive electrode active material particles mainly containing Cu and Sn. The solid electrolyte layer includes a solid electrolyte containing Pb, Sn, and F.
Patent Document 1: Japanese Unexamined Patent Application, Publication No. 2018-73753

### SUMMARY OF THE INVENTION

However, it is desired to improve the initial discharge capacity of the fluoride ion battery.

An object of the present invention is to provide a positive electrode active material capable of improving the initial discharge capacity of a fluoride ion secondary battery.

A first aspect of the present invention is a positive electrode active material for use in a fluoride ion secondary battery. The positive electrode active material includes Cu particles and Bi particles. In an XRD spectrum measured using Cu-Kα rays, a first peak is present in a range where a diffraction angle 2θ is 26.2±0.15 degrees, a second peak is present in a range where the diffraction angle 2θ is 30.4±0.25 degrees, and a third peak is present in a range where the diffraction angle 2θ is 27.0±0.25 degrees.

In a second aspect of the positive electrode active material according to the first aspect, an intensity ratio of the first peak to the third peak is 0.4 or more.

In a third aspect of the positive electrode active material according to the first or second aspect, the Cu particles are nanoparticles.

A fourth aspect of the present invention is a method for manufacturing the positive electrode active material according to any one of the first to third aspects. The method includes implementing a cycle of performing ball mill mixing of a raw material composition including Cu particles, Bi particles, and particles of a compound represented by the following general formula:

KₓBi₁₋ₓF₃₋₂ₓ
where x is 0.02 or more and 0.12 or less,
at a rotation speed of 200 rpm or more and 400 rpm or less for 10 minutes or more and 20 minutes or less, followed by a pause for 5 minutes or more and 20 minutes or less, the cycle being implemented 40 times or more and 120 times or less.

A fifth aspect of the present invention is a fluoride ion secondary battery including a positive electrode material mixture layer including the positive electrode active material according to any one of the first to third aspects.

According to the present invention, it is possible to provide a positive electrode active material capable of improving the initial discharge capacity of a fluoride ion secondary battery.

### BRIEF DESCRIPTION OF THE DRAWINGS

FIGURE shows XRD spectra of powder compositions for positive electrode material mixture layers of Examples 1 to 3 and Comparative Examples 1 to 3.

### DETAILED DESCRIPTION OF THE INVENTION

Hereinafter, an embodiment of the present invention will be described.

### [Positive Electrode Active Material]

The positive electrode active material of the present embodiment is for use in a fluoride ion secondary battery and includes Cu particles and Bi particles. With respect to the positive electrode active material of the present embodiment, in an XRD spectrum measured using Cu-Kα rays, a first peak is present in a range where the diffraction angle 2θ is 26.2±0.15 degrees, a second peak is present in a range where the diffraction angle 2θ is 30.4±0.25 degrees, and a third peak is present in a range where the diffraction angle 2θ is 27.0±0.25 degrees. Therefore, the initial discharge capacity of the fluoride ion secondary battery is improved. As will be described later, it is assumed that this is due to the formation of a fluoride ion conductive compound such as KBiO_{2.35}F₉ during ball mill mixing in the manufacture of the positive electrode active material.

The intensity ratio of the first peak to the third peak is preferably 0.4 or more, and more preferably 0.6 or more. When the intensity ratio of the first peak to the third peak is 0.4 or more, the initial discharge capacity of the fluoride ion secondary battery is improved.

The Cu particles are preferably nanoparticles. This improves the initial discharge capacity of the fluoride ion secondary battery. The particle size of the Cu particles is not limited, and is, for example, 10 nm or more and 100 nm or less.

The mass ratio of the Cu particles to the Bi particles in the positive electrode active material of the present embodiment is not limited, and is, for example, ½ or more and 3 or less. The particle size of the Bi particles is not limited, and is, for example, 20 nm or more and 1 μm or less.

### [Method for Manufacturing Positive Electrode Active Material]

The method for manufacturing a positive electrode active material according to the present embodiment includes implementing a cycle of performing ball mill mixing of a raw material composition including Cu particles, Bi particles, and particles of a compound represented by the following general formula:

KₓBi₁₋ₓF₃₋₂ₓ
where x is 0.02 or more and 0.12 or less,
at a rotation speed of 200 rpm or more and 400 rpm or less for 10 minutes or more and 20 minutes or less, followed by a pause for 5 minutes or more and 20 minutes or less, the cycle being implemented 40 times or more and 120 times or less. This improves the initial discharge capacity of the fluoride ion secondary battery. It is assumed that this is due to the formation of a fluoride ion conductive compound such as KBiO_{2.35}F₉.

The rotation speed for ball mill mixing of the raw material composition is 200 rpm or more and 400 rpm or less, and preferably 300 rpm or more and 350 rpm or less. The time for ball mill mixing of the raw material composition is 10 minutes or more and 20 minutes or less, and preferably 15 minutes or more and 20 minutes or less. The pause time after ball mill mixing of the raw material composition is 5 minutes or more and 20 minutes or less, and preferably 5 minutes or more and 10 minutes or less. The number of times of implementing the cycle of performing ball mill mixing of the raw material composition, followed by a pause is 40 times or more and 120 times or less, and preferably 80 times or more and 100 times or less.

The particles of the compound represented by the above general formula are preferably nanoparticles. The particle size of the particles of the compound represented by the above general formula is not limited, and is, for example, 10 nm or more and 100 nm or less.

The raw material composition may further include a solid electrolyte, a conductivity aid, and the like, in addition to the positive electrode active material. In this case, a powder composition for a positive electrode material mixture layer including the positive electrode active material of the present embodiment is manufactured.

### [Fluoride Ion Secondary Battery]

The fluoride ion secondary battery of the present embodiment includes a positive electrode material mixture layer including the positive electrode active material of the present embodiment. The fluoride ion secondary battery of the present embodiment further includes, for example, a positive electrode current collector foil, a solid electrolyte layer, a negative electrode material mixture layer, and a negative electrode current collector foil.

### (Positive Electrode Material Mixture Layer)

The positive electrode material mixture layer includes the positive electrode active material of the present embodiment, and may further include a solid electrolyte, a conductivity aid, and the like, if necessary. The positive electrode active material of the present embodiment may further include a positive electrode active material other than Cu particles and Bi particles.

The positive electrode active material other than Cu particles and Bi particles is not limited, and examples thereof include particles of a compound represented by the following general formula:

KₓBi₁₋ₓF₃₋₂ₓ
where x is 0.02 or more and 0.12 or less.

The positive electrode active material other than the Cu particles and the Bi particles is preferably nanoparticles. The particle size of the positive electrode active material other than the Cu particles and the Bi particles is, for example, 10 nm or more and 100 nm or less.

The solid electrolyte is not limited as long as it has fluoride ion conductivity and does not defluorinate during discharge of the fluoride ion secondary battery, and examples thereof include metal fluoride particles. Examples of the metal fluoride particles include Ce_{0.92}Sr_{0.08}F_{2.92} particles.

The solid electrolyte is preferably nanoparticles. The particle size of the solid electrolyte is, for example, 10 nm or more and 100 nm or less.

The conductivity aid is not limited as long as it has electron conductivity, and examples thereof include acetylene black.

### (Positive Electrode Current Collector Foil)

The positive electrode current collector foil is not limited as long as it has electron conductivity, and examples thereof include metal foils such as gold foil and platinum foil.

### (Solid Electrolyte Layer)

The solid electrolyte constituting the solid electrolyte layer is not limited as long as it has fluoride ion conductivity and does not defluorinate during discharge of the fluoride ion secondary battery, and examples thereof include metal fluorides. Examples of the metal fluoride include Ce_{0.95}Sr_{0.05}F_{2.85}.

### (Negative Electrode Material Mixture Layer)

The negative electrode material mixture layer includes a negative electrode active material, and may further include a conductivity aid or the like as necessary. The negative electrode active material is not limited, and examples thereof include PbSnF₄ particles. The conductivity aid is not limited as long as it has electron conductivity, and examples thereof include acetylene black.

### (Negative Electrode Current Collector Foil)

The negative electrode current collector foil is not limited as long as it has electron conductivity, and examples thereof include metal foils such as aluminum foil.

The fluoride ion secondary battery of the present embodiment is obtained, for example, by sequentially laminating a positive electrode current collector foil, a powder composition for a positive electrode material mixture layer, a solid electrolyte layer, a powder composition for a negative electrode material mixture layer, and a negative electrode current collector foil, followed by press molding. Here, the powder composition for the positive electrode material mixture layer includes, for example, the positive electrode active material of the present embodiment, a solid electrolyte, and a conductivity aid. The powder composition for the negative electrode material mixture layer includes, for example, a negative electrode active material and a conductivity aid.

Although the embodiment of the present invention has been described above, the present invention is not limited to the above-described embodiment, and the above-described embodiment may be modified as appropriate within the scope of the gist of the present invention.

### EXAMPLES

Examples of the present invention will be described below, but the present invention is not limited to the examples.

(K_{0.06}Bi_{0.94}F_{2.88} Powder)

Potassium fluoride (manufactured by Kojundo Chemical Laboratory Co., Ltd.) and bismuth fluoride (manufactured by Kojundo Chemical Laboratory Co., Ltd.) were weighed and premixed for about 1 hour using an agate mortar and pestle to obtain a raw material mixed powder.

The obtained raw material mixed powder was classified using a stainless steel mesh having an opening of 500 μm. Next, the raw material mixed powder that did not pass through the mesh was mixed using an agate mortar and pestle and then classified, and this operation was repeated until all the raw material mixed powder passed through the mesh.

The weighing, pre-mixing, and classification of the raw materials were carried out in a purge-type (DBO type) glove box (manufactured by Miwa Manufacturing Co., Ltd.) to prevent fluoride from absorbing moisture.

The sealed powder hopper containing the raw material mixed powder after the classification was removed from the glove box and connected to a high frequency induction thermal plasma nanopowder synthesis system TP-40020NPS (manufactured by JEOL Ltd.). Next, argon gas was supplied to the plasma torch, the raw material mixed powder was melted with thermal plasma to form a raw material melt, and the raw material melt was sprayed into a chamber under reduced pressure. The raw material melt sprayed into the chamber was converted into nanoparticles through a cooling step to become K_{0.06}Bi_{0.94}F_{2.88} powder. Subsequently, the K_{0.06}Bi_{0.94}F_{2.88} powder was collected with an exhaust filter, and then the upstream and downstream sides of the exhaust filter were shut off with valves and transported into the glove box, where the K_{0.06}Bi_{0.94}F_{2.88} powder having a particle size of 10 nm or more and 100 nm or less was collected. Here, the composition of the K_{0.06}Bi_{0.94}F_{2.88} powder was analyzed by ICP emission spectrometry.

### (Cu Powder)

A Cu powder having a particle size of 10 nm or more and 100 nm or less was obtained in the same manner as in the case of the K_{0.06}Bi_{0.94}F_{2.88} powder, except that copper (manufactured by Kojundo Chemical Laboratory Co., Ltd.) was used instead of the raw material mixed powder.

(Ce_{0.92}Sr_{0.08}F_{2.92} Powder)

Cerium fluoride (manufactured by Kojundo Chemical Laboratory Co., Ltd.) and strontium fluoride (manufactured by Kojundo Chemical Laboratory Co., Ltd.) were weighed and premixed for about 1 hour using an agate mortar and pestle to obtain a raw material mixed powder.

A Ce_{0.92}Sr_{0.08}F_{2.92} powder having a particle size of 10 nm or more and 100 nm or less was obtained in the same manner as in the case of the K_{0.06}Bi_{0.94}F_{2.88} powder, except that the obtained raw material mixed powder was used. Here, the composition of the Ce_{0.92}Sr_{0.08}F_{2.92} powder was analyzed by ICP emission spectrometry.

### (Powder Composition for Negative Electrode Material Mixture Layer)

Using a pot mill made of silicon nitride having a capacity of 45 mL and 10 balls made of silicon nitride each having a diameter of 10 mm, ball mill mixing of 6 g of lead fluoride (manufactured by Kojundo Chemical Laboratory Co., Ltd.) and 2.8 g of tin (II) fluoride (manufactured by Kojundo Chemical Laboratory Co., Ltd.) was performed. At this time, a cycle of performing ball mill mixing at 600 rpm for 3 hours followed by a 5-minute pause was implemented eight times. Next, 0.619 g of acetylene black was added to 8.669 g of the mixture, and ball mill mixing of the mixture was performed in the same manner as described above, followed by heat treatment at 400° C. for 1 hour in an argon atmosphere to obtain a powder composition for a negative electrode material mixture layer.

(Ce_{0.95}Sr_{0.05}F_{2.85} Powder)

Ball mill mixing of 19.3510 g of cerium fluoride (manufactured by Kojundo Chemical Laboratory Co., Ltd.) and 0.6490 g of strontium fluoride (manufactured by Kojundo Chemical Laboratory Co., Ltd.) was performed, followed by calcining at 1100° C. for 6 hours in an argon atmosphere to obtain a Ce_{0.95}Sr_{0.05}F_{2.85} powder. In ball mill mixing, a cycle of performing ball mill mixing at 600 rpm for 1 hour followed by a 5-minute pause was implemented 40 times.

### Example 1

### (Powder Composition for Positive Electrode Material Mixture Layer)

A powder composition for a positive electrode material mixture layer was prepared in a purge type (DBO type) glove box (manufactured by Miwa Manufacturing Co., Ltd.) filled with Ar gas. Specifically, 0.524 g of Cu powder, 0.175 g of Bi powder (manufactured by Kojundo Chemical Laboratory Co., Ltd.), and 0.267 g of K_{0.06}Bi_{0.94}F_{2.88} powder, as a positive electrode active material, and 0.023 g of acetylene black (manufactured by Denki Kagaku Kogyo Co., Ltd.), as a conductivity aid, were weighed. Next, using a pot mill made of silicon nitride having a capacity of 45 mL and 40 g of balls made of silicon nitride having a diameter of 2 mm, ball mill mixing of the weighed materials was performed in 8 g of cyclohexane, and then the mixture was dried on a hot plate at 65° C. to obtain a powder composition for a positive electrode material mixture layer. In ball mill mixing of the weighed materials, a cycle of performing ball mill mixing at 300 rpm for 15 minutes followed by a 5-minute pause was implemented 40 times.

### (Cell)

A cell was prepared by using an alumina tube having an inner diameter of 10 mm in a purge type (DBO type) glove box (manufactured by Miwa Manufacturing Co., Ltd.) filled with Ar gas. Specifically, first, 150 mg of Ce_{0.95}Sr_{0.05}F_{2.85} powder as a solid electrolyte was uniaxially pressed at a surface pressure of 740 MPa to obtain a solid electrolyte layer. Next, a Pt foil as a positive electrode current collector foil, 10 mg of a powder composition for a positive electrode material mixture layer, a solid electrolyte layer, 30 mg of a powder composition for a negative electrode material mixture layer, and an Al foil as a negative electrode current collector foil were sequentially laminated, and then uniaxially pressed at 700 MPa to obtain a cell. Next, the cell was enclosed in a sealed glass container under a confining pressure of about 340 MPa.

### Example 2

A cell was obtained in the same manner as in Example 1, except that a cycle of performing ball mill mixing at 400 rpm for 15 minutes followed by a 5-minute pause was implemented 40 times in ball mill mixing of the weighed materials.

### Example 3

A cell was obtained in the same manner as in Example 1, except that a cycle of performing ball mill mixing at 300 rpm for 15 minutes followed by a 5-minute pause was implemented 80 times in ball mill mixing of the weighed materials.

### Comparative Example 1

A cell was obtained in the same manner as in Example 1, except that a cycle of performing ball mill mixing at 100 rpm for 15 minutes followed by a 5-minute pause was implemented 40 times in ball mill mixing of the weighed materials.

### Comparative Example 2

A cell was obtained in the same manner as in Example 1, except that a cycle of performing ball mill mixing at 200 rpm for 15 minutes followed by a 5-minute pause was implemented 40 times in ball mill mixing of the weighed materials.

### Comparative Example 3

A cell was obtained in the same manner as in Example 1, except that a cycle of performing ball mill mixing at 200 rpm for 15 minutes followed by a 5-minute pause was implemented 80 times in ball mill mixing of the weighed materials.

### [XRD Spectrum]

The XRD spectra of powder compositions for positive electrode material mixture layers were measured using an automated multipurpose X-ray diffractometer SmartLab (manufactured by Rigaku Holdings Corporation). At this time, Cu-Kα rays (λ=1.5418 Å) were used as the X-rays.

FIGURE shows XRD spectra of powder compositions for positive electrode material mixture layers of Examples 1 to 3 and Comparative Examples 1 to 3.

### [Discharge Capacity]

Using Potentio/Galvanostat SI1287/1255B (manufactured by Solartron), constant current charge-discharge tests were conducted on cells with the inside of the glass container depressurized by a vacuum pump and the glass container placed in a thermostatic chamber at a temperature of 140° C. Specifically, first, after a current of 0.120 mA was applied, a current of 0.040 mA was applied, and charging was performed until the voltage reached 1.5 V (vs. Pb/PbF₂). Next, after a current of 0.120 mA was applied, a current of 0.040 mA was applied, and discharging was performed until the voltage reached −0.5 V (vs. Pb/PbF₂) to determine the discharge capacity.

Table 1 shows the evaluation results of the initial discharge capacity of the cells. The initial discharge capacity is a capacity per 1 g of the positive electrode material mixture layer.

TABLE 1

| | Ball Mill | | | | | Initial |
|---|---|---|---|---|---|---|
| | Mixing | | Diffracted X-ray Peak | | | Dis- |
| | Rotation | | | | Intensity | charge |
| | Speed | Cycle | | | Ratio | Capacity |
| | [rpm] | [time] | 26.2° | 30.4° | (26.2°/27.0°) | [mAhg⁻¹] |
| Example1 | 300 | 40 | Present | Present | 0.72 | 390 |
| Example2 | 400 | 40 | Present | Present | 0.85 | 406 |
| Example3 | 300 | 80 | Present | Present | 1.12 | 497 |
| Comparative | 100 | 40 | Present | Absent | 0.29 | 113 |
| Example1 | | | | | | |
| Comparative | 200 | 40 | Present | Absent | 0.22 | 293 |
| Example2 | | | | | | |
| Comparative | 200 | 80 | Present | Absent | 0.32 | 310 |
| Example3 | | | | | | |

It can be seen from Table 1 that the cells of Examples 1 to 3 each have a high initial discharge capacity. In contrast, the cells of Comparative Examples 1 to 3 each have a low initial discharge capacity because there is no peak in the range of 30.4±0.25 degrees in the XRD spectrum of the positive electrode active material.

What is claimed is:

1. A positive electrode active material for use in a fluoride ion secondary battery, the positive electrode active material comprising
Cu particles and Bi particles,
wherein in an XRD spectrum measured using Cu-Kα rays, a first peak is present in a range where a diffraction angle 20 is 26.2±0.15 degrees, a second peak is present in a range where the diffraction angle 2θ is 30.4±0.25 degrees, and a third peak is present in a range where the diffraction angle 2θ is 27.0±0.25 degrees.

2. The positive electrode active material according to claim 1, wherein an intensity ratio of the first peak to the third peak is 0.4 or more.

3. The positive electrode active material according to claim 1, wherein the Cu particles are nanoparticles.

4. A method for manufacturing the positive electrode active material according to claim 1, the method comprising
implementing a cycle of performing ball mill mixing of a raw material composition comprising Cu particles, Bi particles, and particles of a compound represented by the following general formula:
KₓBi₁₋ₓF₃₋₂ₓ
wherein x is 0.02 or more and 0.12 or less,
at a rotation speed of 200 rpm or more and 400 rpm or less for 10 minutes or more and 20 minutes or less, followed by a pause for 5 minutes or more and 20 minutes or less, the cycle being implemented 40 times or more and 120 times or less.

5. A fluoride ion secondary battery comprising a positive electrode material mixture layer comprising the positive electrode active material according to claim 1.
